(19) United States
(12) Patent Application Publication
(10) Pub. No.: US 2007/0050774 A1
(43) Pub. Date: Mar. 1, 2007

(54) Time-aware systems

(76) Inventors: John C. Eldson, Palo Alto, CA (US); Jerry J. Liu, Sunnyvale, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/210,598

(22) Filed: Aug. 24, 2005

(51) Int. Cl. G06F 9/46

(52) U.S. Cl. 718/104

(57) ABSTRACT

A time-aware system that provides mechanisms for explicitly addressing the timing requirements associated with tasks. A time-aware system according to the present teachings includes a set of resources for use by a task and a resource dedication mechanism that dedicates a subset of the resources for use by the task in response to a set of timing parameters associated with the task.

### BACKGROUND

A variety of systems may be subject to a set of real-world time constraints. For example, a measurement/control system may be subject to a set of time constraints that pertain to device under test, e.g. sample rate, control value update rate, etc.

A system that is subject to a set of real-world time constraints may include some tasks that are subject to the time constraints and some tasks that are not directly subject to the time constraints. A task that is subject to a set of real-world time constraints may be referred to as a hard real-time (HRT) task. One example of an HRT task is a task that performs data sampling at real-world times, rates, etc. that are determined by the physical properties of a device under test. Another example of an HRT task is a task that performs computations for control values to be applied to a system or device at real-world times/rates.

The timing performance of an HRT task may depend on a variety of factors in its execution environment. Examples of factors in an execution environment include the number of tasks currently executing, the computational intensiveness of the tasks, and the capacity of the hardware resources available for supporting the tasks.

One prior technique for meeting a set of time constraints of an HRT task includes assigning the HRT task a relatively high priority for execution. Unfortunately, such a technique does not explicitly address the timing requirements of an HRT task and may amount to no more than a hope that the timing requirements can be met.

Another prior technique for meeting a set of time constraints of an HRT task includes augmenting system hardware resources in the hope of increasing instruction execution performance. For example, a system may be provided with higher performance processors, large amounts of memory, etc. Unfortunately, this technique may amount to no more than a guess of what resources are likely to meet the time constraints of an HRT task.

### SUMMARY OF THE INVENTION

A time-aware system is disclosed that provides mechanisms for explicitly addressing the timing requirements associated with tasks. A time-aware system according to the present teachings includes a set of resources for use by a task and a resource dedication mechanism that dedicates a subset of the resources for use by the task in response to a set of timing parameters associated with the task. Embodiments of a resource dedication mechanism according to the present teachings include hardware mechanisms, software mechanisms, and combination hardware/software mechanisms.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a time-aware system including a set of hardware resources and a resource dedication mechanism according to the present teachings;

FIG. 2 shows an embodiment of a time-aware system in which the hardware resources include a set of processors for executing program code;

FIG. 3 shows an embodiment of a time-aware system in which the hardware resources include a communication switch;

FIG. 4 shows an embodiment of a time-aware system in which the hardware resources include a main memory and a cache memory;

FIG. 5 shows a compiler according to the present teachings;

FIG. 6 shows a time-aware distributed system according to the present teachings;

FIG. 7 shows resource dedication mechanisms in a time-aware distributed system according to the present teachings.

### DETAILED DESCRIPTION

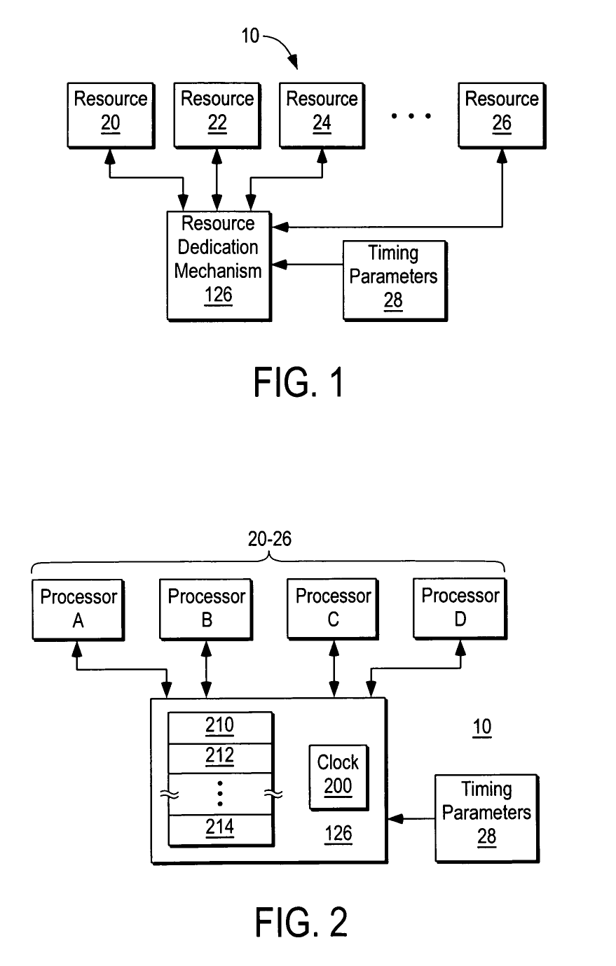

FIG. 1 shows a time-aware system 10 according to the present teachings. The time-aware system 10 includes a set of resources 20-26 and a resource dedication mechanism 126. The resource dedication mechanism 126 dedicates a subset of the resources 20-26 in response to a set of timing parameters 28. The timing parameters 28 may be derived from a set of time constraints associated with a task that is to be executed in the time-aware system 10. The task associated with the timing parameters 28 may be an HRT task in the time-aware system 10.

The resources 20-26 may include hardware resources for supporting execution of tasks in the time-aware system 10. Examples of hardware resources for supporting tasks include processors, memory, specialized computational hardware, communication hardware, input/output devices, application-specific devices, e.g. sensors, actuators, measurement instruments, etc.

The resource dedication mechanism 126 may be a hardware mechanism, a software mechanism, or a combination of hardware/software. The resource dedication mechanism 126 dedicates resources to a task by allocating resources for appropriate time periods needed to guarantee that the timing parameters 28 will be met.

FIG. 2 shows an embodiment of the time-aware system 10 in which the resources 20-26 include a set of processors A-D for executing program code. The resource dedication mechanism 126 in this embodiment includes a clock 200 and a set of registers 210-214. The clock 200 provides a time-of-day time value and the registers 210-214 are for holding the timing parameters 28.

The timing parameters 28 may include a specification of a time period and an identifier for one or more of the resources 20-26. For example, the timing parameters 28 may specify a start time T_{S} and an end time T_{E} and an identifier of the hardware resource 20 to indicate that the hardware resource 20 is to be dedicated for performing a task starting at time T_{S} and ending at time T_{E}. The timing parameters 28 may specify repeating time intervals. The timing parameters 28 may be used as parameters for a “time bomb” or repeating “time bomb” for dedicating a specified hardware resource.

The resource dedication mechanism 126 generates a start signal when the contents of the registers 210-214 and the clock 200 indicate that one or more of the processors is to be dedicated to a task. For example, the resource dedication mechanism 126 generates a start signal when the time in the clock 200 matches the start time T_{S}. In addition, the resource dedication mechanism 126 generates an end signal when the time in the clock 200 matches the end time T_{E}.

The start and the stop signals from the resource dedication mechanism 126 are provided to the processors A-D that are specified in the registers 210-214, the start and stops signals may be provided to an interrupt line to the processors A-D or via an input register or memory mapping that is readable by processors A-D. In response to a start signal a processor dedicates itself to the task associated with the start signal and in response to the stop signal a processor returns to normal processing.

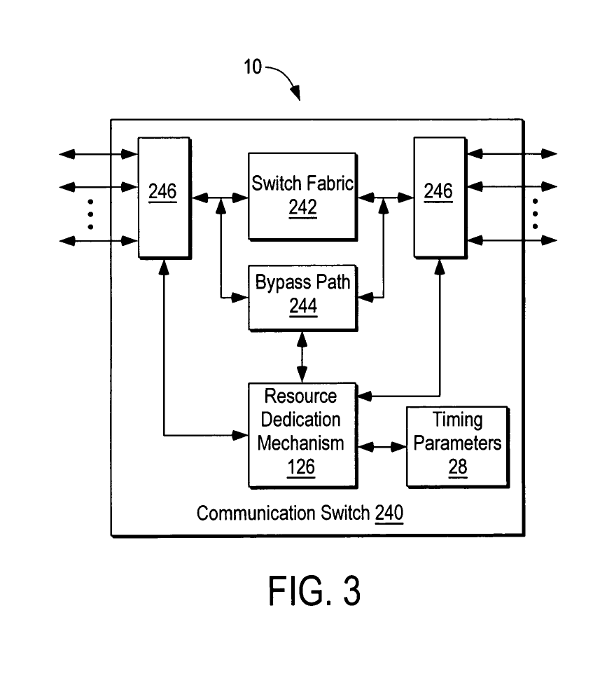

FIG. 3 shows an embodiment of the time-aware system 10 in which the resources 20-26 include a communication switch 240 that may be dedicated to a task in response to the timing parameters 28. The resource dedication mechanism 126 generates a start signal to indicate that resources in the communication switch 240 are to be dedicated to a particular task and generates an end signal when dedication of the resources in the communication switch 240 to the task is to end.

The communication switch 240 includes a switch fabric 242 for routing messages between a set of input ports 246 and a set of output ports 248. The input ports 246 include queues for holding messages while the switch fabric 242 is busy. The start signal from the resource dedication mechanism 126 causes the input ports 246 to send incoming messages associated with the particular task to the output ports 248 via a bypass path 244. The bypass path 244 carries messages associated with the particular task across the switch and bypasses the queues in the input ports 246 while the communication switch is dedicated to the particular task. The end signal from the resource dedication mechanism 126 returns the switch to normal mode and use of the switch fabric 242 to transfer all messages between the input and output ports 246 and 248.

In another embodiment, the switch fabric 242 is partitioned and a portion of the switch fabric 242 is dedicated to the particular task in response to the start and end signals from the resource dedication mechanism 126. For example, half of the switch fabric 242 may be dedicated to handling messages associated with the particular task while the remaining half of the switch fabric 242 handles all other traffic. The messages associated with the particular task may be identified by a predetermined code in the messages.

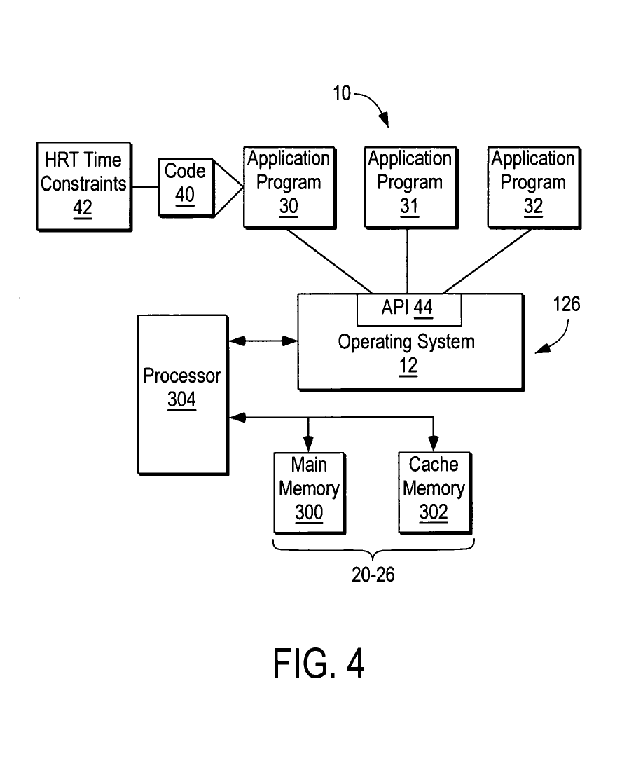

FIG. 4 shows an embodiment of the time-aware system 10 in which the resources 20-26 include a main memory 300 and a cache memory 302. The resource dedication mechanism 126 in this embodiment includes an operating system 12 that allocates hardware resources to a set of application programs 30-32 in response to timing parameters that are derived from HRT time constraints associated with the application programs 30-32. For example, the application program 30 includes a set of code 40 that performs an HRT task according to a set of HRT time constraints 42. The code 40 may be a thread executing under the operating system 12. The application programs 30-32 and the operating system 12 are executed by a processor 304.

In one embodiment, the operating system 12 uses the arming mechanism to move data associated with an HRT task from the slower main memory 300 into the faster access cache memory 302. For example, the operating system 12 moves data associated with the code 40 from the main memory 300 into the cache memory 302 in response to an arming signal. The faster data access provided by a cache memory 302 enables the time-aware system 10 to meet the HRT time constraints 42. The cache memory 302 provides memory latency times that are predictable while the main memory 300 latency times may not be predictable. For example, if the main memory 300 is on a bus shared with other devices, e.g. video cards, stalls may occur for main memory accesses. The cache memory 302, on the other hand, is owned exclusively by the processor 304. The latency time can therefore be predicted accurately.

The processor 304 in one embodiment includes instructions for managing the cache memory 302. For example, processor 304 includes page lock instructions for locking specified memory pages in the cache memory 302. The page lock instruction may be used to guarantee that a set of data associated with an HRT task will be delivered from the cache memory 302 within a specified time to meet a set of HRT time constraints. The page lock instructions are locking pages in the cache memory 302 according to same timing configuration, such as start time, stop time, duration. This helps guarantee that the pages are in the cache memory 302 at a specified time.

The operating system 12 provides system services via an application programming interface (API) 44 to the application programs 30-32. The system services enable dedication of memory resources to HRT tasks. The system services take as parameters the timing parameters 28 which include a time specification for memory resource dedication. A dedication of selected memory resources enables a guarantee that a set of HRT time constraints associated with an HRT task can be met. An arming mechanism may be used to minimize any waste in dedicated memory resources. For example, a memory resource may be shared until the occurrence of an arming signal so that the arming signal causes the memory resource to transition within a known time to a dedicated and assigned resource of an HRT task. The assignment may be specified with the arming signal or may be pre-assigned.

An arming signal for allocating and/or dedicating a memory resource may be generated by hardware or software. An arming signal for allocating and/or dedicating a memory resource may be an external arming signal, a network arming signal, an internal time-based arming, or an arming initiated by the operating system 12. In one embodiment, the operating system 12 receives an interrupt from an IEEE 1588 clock that specifies an arming period.

The application programming interface API 44 enables the application program 30 to provide an execution environment specification for the code 40. The execution environment specification may include an indication to assign the code 40 to a particular set of memory resources, e.g. to a particular page of memory, or to a particular processor or processors, or to particular application-specific hardware.

The operating system 12 generates a fault event if a set of HRT time constraints are not met. In one embodiment, the operating system 12 includes a completion time bomb which is defused if completion of an HRT task precedes the expiration of a completion time specified in its HRT time constraint. The completion time bomb fires and generates an event if an HRT task fails to complete in time to meet its HRT time constraints. This mechanism may be used for any continuing action having mandatory completion time. Examples include receipt or sending of a particular message on a network, setting via the operating system 12 of hardware configuration or parameters such as time bombs, etc.

The application programs 30-32 may include time-based tasks that repeat, e.g. the application program 30 may periodically repeat the code 40. The operating system 12 employs repeating time bombs to support the repeating time-based code.

The API 44 provide arming and triggering functions to the application programs 30-32. The API 44 may be used to bind HRT tasks to underlying hardware, thereby enabling assignment/dedication of specified hardware resources to HRT tasks. The hardware resources that may be bound to HRT tasks include memory resources, e.g. the cache memory 302 and the main memory 300, as well as other hardware resources, e.g. network communication resources, processor resources, application-specific hardware, etc.

The operating system 12 presents an event model for time-based actions to the application programs 30-32 via the API 44. The application programs 30-32 are structured as a collection of actions with explicit time guarantees, e.g. when an application starts, its maximum duration, etc. The operating system 12 views code to be executed as a collection of code snippets with time specifications, e.g. the code 40 has the HRT time constraints 42. The operating system 12 executes the code snippets at the specified time(s) and provides error indicators if snippets do not complete according to time-specifications.

The resource dedication mechanism 126 in this embodiment includes a compiler 14. The compiler 14 generates the code 40 to manage memory in response to the HRT time constraints 42.

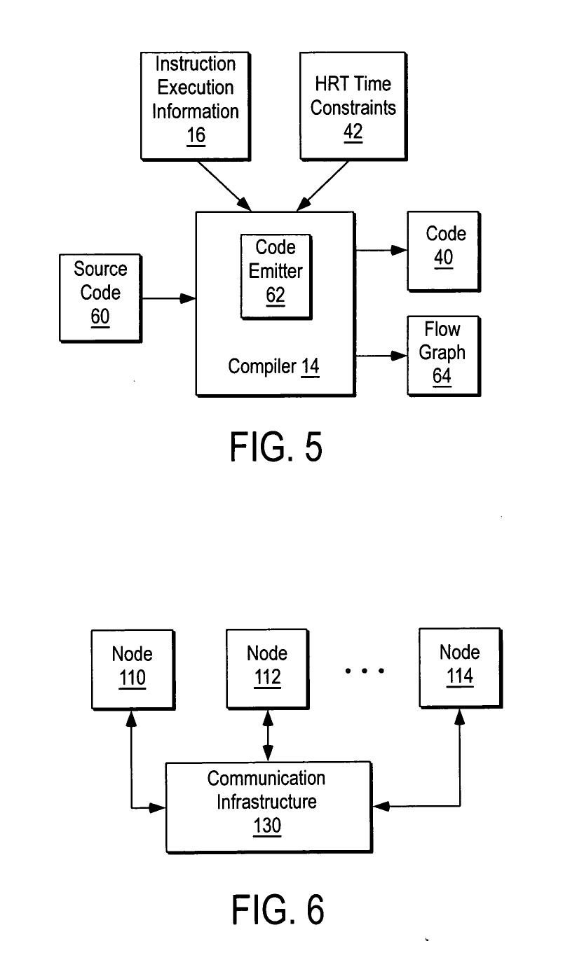

FIG. 5 illustrates the functions of the compiler 14 according to the present teachings. The compiler 14 generates the code 40 in response to a source code 60. The compiler 14 makes a pass thru the source code 60 to identify memory accesses. The compiler 14 emits memory management instructions in the code 40 that manage memory paging explicitly rather than leaving memory paging at run time for the operating system 12. The compiler 14 emits memory management instructions to eliminate memory access latency variability.

The compiler 14 includes a code emitter 62 that emits the code 40 so as to maximize adherence to the HRT time constraints 42. The compiler 14 takes as an input a set of instruction execution information 16 that pertains to the time execution performance of instructions in the code 40. The instruction execution information 16 specifies the number of cycles particular instructions take to execute, and whether particular instructions may stall, etc.

The compiler 14 generates a flow graph 64 of the code 40 and predicts the needed time to execute the code 40 using the instruction execution information 16. The compiler 14 predicts an amount of time for execution of non-memory access instructions in the code 40 using the instruction execution information 16. The compiler 14 arranges the code 40 to eliminate any variable memory latency (assuming the memory is not shared) when predicting execution time of memory access instructions in the code 40. For example, the compiler 14 makes a pass through the source code 60 and identifies regions that involve memory access. Then before emitting code for the region, the compiler 14 emits code for fetching all needed data from the main memory 300 into the cache memory 302. The compiler 14 emits code to shadow all writes to the main memory 300 in its own private cache memory, and augments memory fetch instructions with fetches from private memory to eliminate the uncertainty in memory access. This provides a trade off of possible performance for predictability. The instructions that are emitted to manipulate the memory may not be the most optimal ones, but will guarantee that the code executes within bounded time.

In one embodiment, the compiler 14 generates a timing specification and a resource requirement list for the code 40. For example, the compiler 14 may generate a message such as “this binary will execute in 5.4 ms for a 200 MHz clock in a X class architecture, with requirements for 7 processing pipelines, 28 registers, and 250200 bytes of cache memory.”

FIG. 6 shows an embodiment of the time-aware system 10 in which the resources 20-26 include a set of nodes 110-114 and a communication infrastructure 130. The nodes 110-114 exchange messages via the communication infrastructure 130 when performing a distributed application in the time-aware system 10.

A distributed application in the time-aware system 10 may include a set of HRT time constraints. The capability of the time-aware distributed system 10 for meeting the HRT timing constraints depends on the capability of the communication infrastructure 130 to provide message transfer among the nodes 110-114. For example, the communication infrastructure 130 may cause latency and jitter in the timing of message transfer among the nodes 110-114.

The latency and jitter of the communication infrastructure 130 may be bounded to an appropriate degree of accuracy in order to meet the HRT time constraints of a distributed application in the time-aware system 10. In addition, the transfer of messages via the communication infrastructure 130, e.g. arming messages and trigger messages that pertain to meeting a set of HRT time constraints, may be scheduled in response to the bounds on latency and jitter.

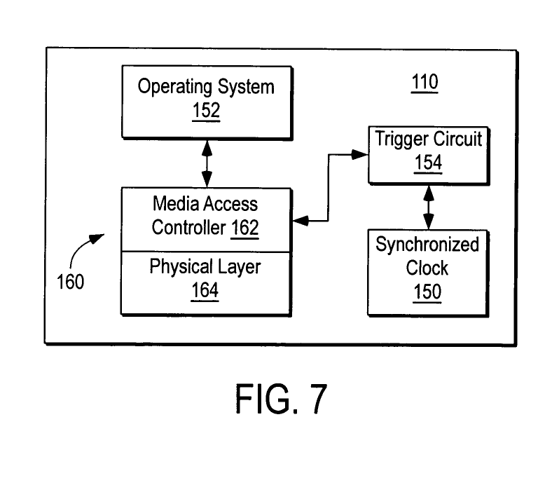

FIG. 7 shows embodiments of the resource dedication mechanism 126 in the node 110. Each of the nodes 110-114 may include similar mechanisms as shown for the node 110.

The resource dedication mechanism 126 in the node 110 includes a synchronized clock 150. In one embodiment, the synchronized clock 150 is a clock that conforms to the IEEE 1588 clock synchronization standard. The IEEE 1588 standard provides a common sense of time for the time-aware distributed system 10. The common sense of time enables actions by the node 110 to be specified based on time. For example, event triggers may be specified by event times carried in messages on the communication infrastructure 130. Similarly, arming periods may be specified by a timing specification carried in messages on the communication infrastructure 130. The synchronized clock 150 may be used as a hardware source for triggering the appropriate event and starting and ending the appropriate arming function in response to the contents of the trigger and arming messages.

The effects of latency and jitter in message transfer to and from the node 110 may degrade the accuracy of the synchronized clock 150 according to the IEEE 1588 protocol because synchronization is based on the transfer of timing messages via the communication infrastructure 130. In addition, latency and jitter may prevent a message from arriving at the node 110 before an event time that is associated with the message. As a consequence, latency and jitter in the communication infrastructure 130 may influence the capability of a distributed application to meet its HRT time constraints.

The resource dedication mechanism 126 in the node 110 includes an operating system 152 that manages the transfer of messages via the communication infrastructure 130 in response to the bounds on latency and jitter. In addition, the resource dedication mechanism 126 in node 110 include a trigger circuit 154 for triggering message transfer to the communication infrastructure 130 at the appropriate times.

A communication subsystem 154 in the node 110 includes a protocol stack 160 that enables message transfer via the communication infrastructure 130. The protocol stack 160 includes a media access controller (MAC) 162 and a physical (PHY) layer 164. The MAC 162 includes queues for holding messages to be transferred and messages being received. The MAC 162 and the PHY 164 include mechanisms for reducing latency and jitter in message transfer.

In one embodiment, the resource dedication mechanism 126 in the node 110 includes reserved codes are used in messages associated with HRT tasks. The MAC 162 inserts the reserved codes into messages obtained from an application program on the fly and performs the appropriate adjustment of message length and FCS for message transmission. The reserved codes may be used alone or to define segments within a message in which arming or triggering semantics may be implemented. Upon receipt of a message, the MAC 162 detects the reserved codes and in response generates the appropriate action and strips out the reserved codes so that the original message is undisturbed. This technique may be used to reduce the latency while a message is in the process of transmission on a physical media. IPV6 headers may be used in like manner at the start of a message transmission.

In another embodiment, the resource dedication mechanism 126 in the node 110 includes a mechanism for changing the priority in the queues of the MAC 162 in real-time, thereby reducing latency and jitter in message transfer is. In another embodiment, the resource dedication mechanism 126 in the node 110 includes a mechanism for preassembling messages inside the MAC 162 thereby avoiding latency and jitter caused by protocol levels higher than the MAC 162 including the operating system 152. In another embodiment, the resource dedication mechanism 126 in the node 110 includes a mechanism for arming inside the MAC 162 to reserve bandwidth for messages associated with an HRT task. In another embodiment, the resource dedication mechanism 126 in the node 110 include a mechanism for signaling at layer 1 of the protocol stack 160 under certain circumstances. For example, signaling may be implemented using one channel of a multiplex—either time based as in TDMA (e.g. SERCOS), wavelength, or frequency.

In yet another embodiment, the resource dedication mechanism 126 in the node 110 includes a mechanism for encoding in the PHY 164. For example, the 4B/5B encoding used in 100BT and other high speed protocols includes unused bit patterns. The unused bit patters are typically not used because they do not typically meet other signaling requirements such as average transmit power (zero mean) issues. Given that arming and signaling are usually significantly less frequent than the signaling rates, an occasional use of the unused codes for arming, triggering, etc., may be employed. The PHY 164 inserts of one of the unused codes when sending a message in response to a real time event. The PHY 164 detects the unused codes and strips off the unused codes when receiving a message thereby reducing the latency that would otherwise be caused by queuing the message to effectively a symbol time.

If the communication infrastructure 130 includes a communication switch then the communication switch recognizes the unused codes in a message received at an input port, strips out the unused codes while signaling its output ports to insert the unused codes in a current outgoing messages, thereby removing a latency otherwise associated with the communication switch. In other words an encoded arming signal on incoming message A may be distributed to other nodes via a completely different message on other ports. The selection of which nodes to distribute the encoding on may be preconfigured, in some cases be part of the encoding or may be time based within the communication switch, or may be multicast.

The resource dedication mechanism 126 may include a time-aware compiler that is adapted to dedicating a variety of resources in the time-aware system 10. The role of the prior art compiler may be characterized as transforming a software program, represented in a programming language, into a set of instructions that orchestrate the activities of the various components within a CPU to execute an instruction. These may be referred to as CPU-level instructions. A prior art compiler may have knowledge about the composition of different classes of CPUs, and the capabilities of the components of CPUs, and may emit code for a particular CPU based on command line options. For example, a compiler may know that certain CPUs have 1 floating point unit while another one may have 2, and may schedule sequences of instructions accordingly.

A time-aware complier according to the present teachings emits instructions and configuration settings that orchestrate the actions of the resources of the entire time-aware system 10, not for just one CPU on one particular node of a system as with prior art compilers. A time-aware compiler emits binary artifacts to control many types of resources, e.g. CPUs, measurement front-ends, communication buses, networking, etc., in response to a temporal description of the activities of an entire system, e.g. the timing parameters 28. The temporal description may be represented in a program. The binary artifacts may be manifested in the form of traditional binary code for a CPU and may also take the form of configuration settings for other resources, e.g. configuration settings for a measurement circuit, a communication device, etc. If there are multiple CPUs in a system, instructions may be emitted for each CPU. The various resources need not explicitly communicate with one another via messages, as is the case with prior art compilers. Instead, given a common notion of time and synchronized clocks, the actions for the various resources may be implicitly synchronized by a compiler when the instructions for the various system resources are emitted.

A time-aware compiler may be aware of the internal composition of a system including descriptions of a number of systems and knowledge of information such as types of resources, e.g. CPU, router, measurement front end, etc., and how the resources are connected, and the nature of configuration settings the resources accept, e.g. a CPU accepts binary code, a router may accept an different binary code, etc.

A high level programming language may be used to represent a temporal program for the time-aware system 10. Such a high level programming language may include constructs for a time-aware compiler to emit sequences of instructions to perform actions such as configuring a particular router.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A time-aware system, comprising:
a set of resources for use by a task;
resource dedication mechanism that dedicates a subset of the resources for use by the task in response to a set of timing parameters associated with the task.

2. The time-aware system of claim 1, wherein the timing parameters are derived from a set of time constraints associated with the task.

3. The time-aware system of claim 2, wherein the resource dedication mechanism generates a fault event if the time constraints are not met.

4. The time-aware system of claim 1, wherein the resource dedication mechanism includes an operating system that assigns a set of code associated with the task to one or more of the resources in response to the timing parameters.

5. The time-aware system of claim 1, wherein the resource dedication mechanism includes an arming mechanism for one or more of the resources.

6. The time-aware system of claim 1, wherein the resource dedication mechanism includes a compiler that emits a set of code for managing a set of memory resources in response to the timing parameters.

7. The time-aware system of claim 1, wherein the resource dedication mechanism includes a compiler that emits a set of code for configuring one or more of the resources in response to the timing parameters.

8. The time-aware system of claim 1, wherein the resource dedication mechanism includes a mechanism for dedicating a portion of a communication switch to the task.

9. The time-aware system of claim 1, wherein the resource dedication mechanism includes an operating system that moves a set of data associated with the task from a main memory to a cache memory in response to the timing parameters.

10. The time-aware system of claim 1, wherein the resource dedication mechanism includes a synchronized clock in each of the set of nodes of the time-aware system such that the synchronized clocks enable dedication of the resources in response to the timing parameters.

11. A method for time-aware processing, comprising:
executing a task in the time-aware system;
dedicating a subset of the resources for use by the task in response to a set of timing parameters associated with the task.

12. The method of claim 11, further comprising deriving the timing parameters from a set of time constraints associated with the task.

13. The method of claim 12, further comprising generating a fault event if the time constraints are not met.

14. The method of claim 11, wherein dedicating includes assigning a set of code associated with the task to one or more of the resources in response to the timing parameters.

15. The method of claim 11, wherein dedicating includes arming one or more of the resources.

16. The method of claim 11, wherein dedicating includes compiling a set of code for managing a set of memory resources in response to the timing parameters.

17. The method of claim 11, wherein dedicating includes compiling a set of code for configuring one or more of the resources in response to the timing parameters.

18. The method of claim 11, wherein dedicating includes dedicating a portion of a communication switch to the task.

19. The method of claim 11, wherein dedicating includes moving a set of data associated with the task from a main memory to a cache memory in response to the timing parameters.

20. The method of claim 11, wherein dedicating includes synchronizing clock in each of the set of nodes of the time-aware system such that the synchronized clocks enable dedication of the resources in response to the timing parameters.
